(19) United States
(12) Patent Application Publication
(10) Pub. No.: US 2012/0233321 A1
(43) Pub. Date: Sep. 13, 2012

(54) NETWORK STRUCTURE AND METHOD OF ITS USE FOR TENANT SPECIFIC MEASUREMENT OF RESOURCE UTILIZATION IN A MULTI-TENANT SYSTEM FOR THE PURPOSES OF REPORTING, RATING AND ACCESS CONTROL

(75) Inventors: Christian Dreke, Portland, OR (US); Gregory A. Kim, Happy Valley, OR (US)

(73) Assignee: Accumulus Corporation, Portland, OR (US)

(21) Appl. No.: 13/414,560

(22) Filed: Mar. 7, 2012

Related U.S. Application Data
(60) Provisional application No. 61/450,042, filed on Mar. 7, 2011.

(51) Int. Cl. G06F 15/173

(52) U.S. Cl. 709/224

(57) ABSTRACT

A system and method for metering the use of network-accessible computer resources by multiple users, each user being associated with two or more tenant client computing device connected to a multi-tenant system via a network. The multi-tenant system includes a load balancer and access control device, a server computing device, and a consolidated user store. Requests to use resources of the multi-tenant system are generated by one of the tenant client computing devices and are received by the load balancer and access control device. In response to such requests, the system executes usage measurement initiation instructions, processes usage measurement computation instructions and records usage measurement data, periodically detects recordation of the usage measurement data in said local memory cache, and aggregates said usage measurement data in said consolidated user store.

### CROSS-REFERENCE TO RELATED APPLICATIONS

This application claims the benefit of provisional application Ser. No. 61/450,042 filed Mar. 7, 2011, and is incorporated herein in its entirety.

### BACKGROUND OF THE INVENTION

1. Field

The present invention pertains to measurement of resource usage in a multi-tenant system. More particularly, the present invention pertains to server assisted measuring of tenant specific resource utilization in a multi-tenant system for the purpose of reporting, rating and/or access control.

2. Background Information

A network may be defined as a group of connected computers that allows systems to share information and equipment. For example, a client to server network may consist of one or more client computing devices and one or more server computing devices connected to each other via standard network protocols such as TCP/IP. Client organizations (also referred to herein as “tenants”) may use their client computing device(s) to communicate directly or indirectly through a network with services fulfilled on server computing devices.

A multi-tenant system (MTS) may be defined as a set of services fulfilled via one or more server computing device(s) and made accessible via a network to a multiplicity of client computing devices belonging to a multiplicity of tenants. Further, a server computing device may correspond to a physical or a virtualized server containing a set of physical or virtualized resources, including but not limited to a Central Processing Unit (CPU), Random Access Memory (RAM), a storage device, and a network interface for communication with external systems.

Tenants access said multi-tenant system services at varying frequency and in varying quantity. Further, each service access by said tenants results in a measurable amount of resource use. Resources are typically measured in two different ways. The first, running total, is accomplished by keeping a running total of hardware resource usage over a period of time, measured in terms of hardware use. Examples of running total type resource measurements are number of accesses, CPU time, and network bandwidth. The second, snapshot, is accomplished by periodically taking a snapshot of the amount of usage. An example of a snapshot type resource measurement is disk storage amount.

Both of these technologies have been used by companies to understand the resource usage of their computer systems. In the past, these measurements would typically be done against a single computer and the computer would run applications dedicated to a single tenant. What has changed with the Internet cloud is that companies now often use many computers to run an application and offer MTS services to many tenants. To effectively support this new computing model, an MTS provider must be able to collect and aggregate resource usage from many computers and know how much resources each tenant used. In addition, resources need to be measured with units meaningful to the tenant. Support for units beyond the traditional CPU use, memory use, network use and disk use is important.

The ability to measure the resource use of tenants in meaningful service units is valuable for a variety of business purposes, including metering, managing, and billing. In any business model in which network services are sold, the amount of system resources used is often the most commercially viable basis to determine an appropriate fee.

Further, in a multi-tenant system, one tenant may utilize an excessive amount of the system's services, potentially depriving other tenants of proper access to said system. Accordingly, there is a need for a method which will accurately measure or approximate resource usage on a per tenant basis for the purpose of access control and prevention of overuse.

By way of illustration, most cloud service providers can meter how much hardware use a particular cloud customer uses and bill them on that basis. However, if that cloud customer in turn sells software services to customers, it needs to know how much resources and what type of resources each customer uses. For example, such a provider may sell downloadable media, and needs to bill its customers depending on the amount of network resources each has used. A more intuitive billing model would charge a customer not on hardware use but rather on units of media downloaded (e.g., songs or images).

Providing this measurement creates significant challenges. It requires a metering system that is sufficiently flexible and granular to look beyond hardware use and divide resource use into units of service provided, so that it counts the number of songs downloaded or games played in addition to the amount of memory used and bits of data transmitted. Additionally, this resource use must be quantified in some way that places a minimum amount of extra burden on the computing nodes which do the work involved, in order to avoid impact on latency of processing. A metering system should extract localized usage data off the processing nodes as efficiently as possible and without noticeably impacting overall system performance. The data should then be combined or aggregated for reporting, rating, and access control, so that usage on any number of virtual machines can be attributed to the same user or use.

Measuring systems based solely on metering network traffic do not have sufficient local observational capability to measure local resource usage and consolidate it. Local disk usage, CPU, and other local resource usage data is not accessible to a metering system which relies on monitoring network traffic to detect or infer resource use. Cloud vendors often price their services based on local usage like disk usage or CPU usage so MTS providers need to understand how much each tenant is using of these types of resources to increase profitability. Metering systems that do not include local observational capability cannot measure as precisely local usage.

### SUMMARY OF THE INVENTION

Disclosed is a method and apparatus for tenant specific measurement of resource utilization in a multi-tenant system for the purposes of reporting, rating and access control.

The foregoing and other objectives, features, and advantages of the invention will be more readily understood upon consideration of the following detailed description of the invention taken in conjunction with the accompanying drawings.

### BRIEF DESCRIPTION OF THE DRAWINGS

FIG. 1 is a schematic diagram showing two tenant client computing devices adapted to be coupled to one multi-tenant system (MTS), according to one embodiment of the invention. In addition, FIG. 1 shows said MTS consisting of one load balancer and access control system, two server computing devices and one consolidated usage store, according to one embodiment of the invention.

FIG. 2 is a schematic diagram showing an example of resource utilization measurement for a service fulfilled by a multi-tenant system accessed by a tenant client computing device.

FIG. 3 is a schematic diagram showing an example of a method, after the initial scenario of FIG. 2, of sending a multiplicity of resource utilization measurements from a server to a persistent store for the purpose of combining said measurements with any already present in said store.

### DETAILED DESCRIPTION OF PREFERRED EMBODIMENTS

An example of the structure and use of a resource utilization measurement system, according to the present invention, will now be explained in the context of two tenant client computing devices coupled via a network to one multi-tenant system, where said multi-tenant system consists of one load balancer and access control device, two server computing devices, one consolidated usage store, and one network. Any network would suffice. Any number of tenant client computing devices and any number of server computing devices may participate.

A tenant client wishes to use a service provided by a tenant. Tenant client uses a tenant client computing device to initiate a request to use service. Tenant client computing device connects through a network to a load balancer and access control device. Load balancer and access control device routes request to a server computing device to perform service.

Upon receipt of said request message, server computing device assigns a thread of execution to process said request message. The thread of execution needs to be prepared before use. To prepare a thread of execution for measuring tenant specific usage, usage measurement initialization instructions are performed on the server. These instructions perform functions that include but are not limited to: optionally setting usage counters to a value, recording initial values for usage counters and setting a tenant context for the thread of execution. An example of setting a usage counter is zeroing a counter that will be used to record the number of accesses of a resource. An example of recording the initial value for a usage counter is saving the current time for a counter that will be used to record the amount of time a resource was used. An example of setting a tenant client context is attaching a unique tenant client identifier to the thread of execution through known mechanisms so that server resources will be better able to monitor usage by the tenant.

Upon completing service specified by request message, server computing device processes a set of usage measurement computation instructions to determine the resource use that occurred while performing service by computing the difference between the initial resource use measure(s) and the current resource use measure(s). Upon having determined the resource use measure(s) that occurred as a result of fulfilling service, server computing device records resource usage measure(s) into a local usage cache.

A separate thread of execution processing a different set of instructions within the server computing device periodically checks the local usage cache to determine if resource usage information has been added. If resource usage information has been added, said thread of execution sends a message containing said information to a persistent consolidated usage store via a network. Upon receipt, said consolidated usage store adds said information to information already present in the consolidated usage store. Consolidation methods may include but are not limited to adding received resource use measure information to resource use measure information already present, averaging new and existing resource use measure information, or computing and persisting the maximum value of new and existing resource use information. After sending resource usage information to consolidated usage store said thread of execution removes said resource usage information from local usage cache.

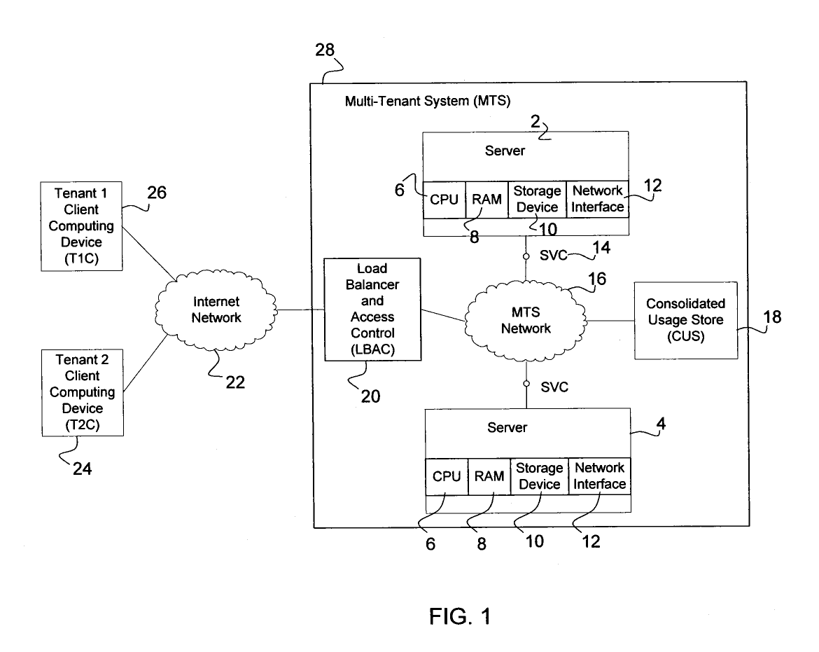

FIG. 1 is a schematic diagram showing two tenant client computing devices 24 and 26 adapted to be coupled to one multi-tenant system 28 via one Internet Network 22 and one Load Balancer and Access Control system 20. FIG. 1 also shows two servers 2, 4 adapted to be coupled to one Load Balancer and Access Control system 20 and to one Consolidated Usage Store 18 via one MTS Network 16, according to an embodiment of the present invention. In this context, a Load Balancer and Access Control system 20 routes client computing device requests to a multiplicity of servers 2, 4. Servers comprise CPU 6, RAM 8, Storage Device 10, and Network Interface 12 components.

Each client computing device 24, 26 is able to transmit request messages to a multi-tenant system (MTS)28 and receive response messages from said MTS. For example, each of the client computing devices 24, 26, Load Balancer and Access Control system (LBAC) 20, servers 2, 4 and Consolidated Usage Store (CUS) 18 may use their respective processors (in a known manner) to execute software such as Microsoft™ Winsock application programming interface (API). Microsoft™ Winsock API uses Transmission Control Protocol/Internet Protocol (TCP/IP) to divide messages into packets and send the packets from software on one client or server to software on another client or server via a network such as the Internet.

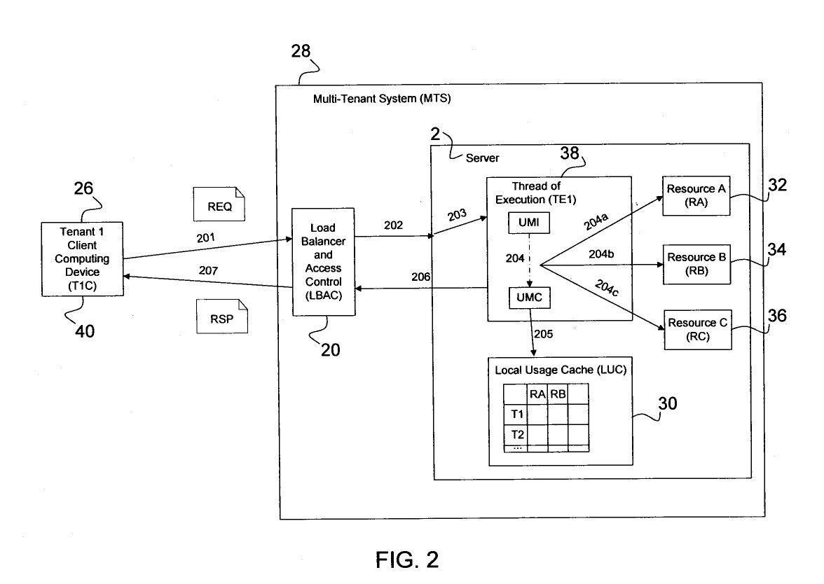

Referring to FIG. 2, a client 26 sends a request message (REQ) via a client computing device 40 to the multi-tenant system (MTS) 28 indicating the client's desire to use a service (SVC). This action is represented by reference numeral 201. The Load Balancer and Access Control system (LBAC) 20 having received said request message, routes said message to a server 2 for processing, as represented by reference numeral 202. As shown by reference numeral 203, Server 2 having received said request message, starts processing said request message by starting a new thread of execution (TE1) and instructing it to fulfill service SVC for client 40. Next, the thread of execution TE1 processes usage measurement initialization (UMI) instructions for resources to be measured (32, 34, and 36 in this example). These instructions perform functions that include but are not limited to: optionally setting usage counters to a value, recording initial values for usage counters and setting a tenant context for the thread of execution. As shown by reference numeral 204, TE1 processes instructions which fulfill said service SVC utilizing said resources 32, 34, 36 in 204a, 204b, 204c respectively in the process. Upon fulfillment of service SVC, in 205, thread of execution TE1 processes usage measurement computation (UMC) instructions which measure the current resource usage of running total type usage by TE1 through a known mechanism for those resources to be measured (32 and 34 in this example). Next, in 205, for each of said resources, thread of execution TE1 determines the resource usage measure which occurred during the fulfillment of service SVC by determining the change in resource usage from the initial resource usage and the current resource usage for said thread of execution TE1. Further, the thread of execution TE1 processes instructions which add said computed resource usage measures to the Local Usage Cache (LUC) 30 and associate said usage with tenant associated with said client 26. In 206, the thread of execution TE1 sends a response message RSP to LBAC 20. Next, in 207, LBAC 20 forwards said response message RSP to said client 26 client computing device 40.

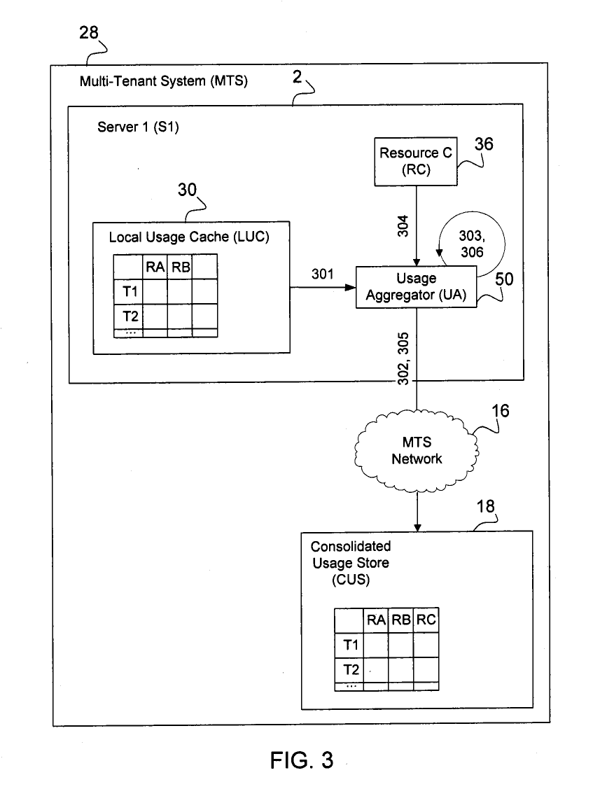

FIG. 3 illustrates the Usage Aggregator (UA) system 50 that processes continuously to transfer new resource usage information into the Consolidated Usage Store (CUS) 18 pursuant to the following events, according to one embodiment of the current invention. Upon start of operation, UA 50 processes a set of instructions described in this example continuously. First, as indicated by reference numeral 301, UA 50 checks if new resource usage information has been added to the Local Usage Cache (LUC) 30 on the server 2. The LUC 30 contains running total type usage. As indicated by reference numeral 302, if said information has been added, UA 50 sends a message to CUS 18 containing said information via a network 16. Next, UA 50 removes said information from said LUC 30. As shown by reference numeral 303, UA 50 suspends processing of LUC 30 (running total type) usage for a configurable amount of time. After suspending LUC 30 (running total type) usage processing for said configurable amount of time, UA 50 loops to process instructions described in the action indicated by reference numeral 301.

As indicated by reference numeral 304, UA 50 checks if new resource usage information of a snapshot type has been recorded. As indicated by reference numeral 305, if said information has been added, UA 50 sends a message to CUS 18 containing said information via a network 18. As indicated by the reference numeral 306, UA 50 suspends processing of snapshot type usage for a configurable amount of time. After suspending snapshot type usage processing for said configurable amount of time, UA 50 loops to process instructions described in the process indicated by reference numeral 304.

As indicated by reference numerals 302 and 305, upon receipt of said message containing said resource usage information, CUS 18 persists said information according to a configurable consolidation method. For each resource type contained in said information, said consolidation method may include but is not limited to computing the sum, the maximum or the average of existing resource usage for said tenant and said resource usage for said tenant.

Because the system and method described herein meters usage within the node that performs the relevant processing, it can measure use precisely and flexibly enough to permit a tenant to meter the use of individual users or individual uses. It can describe this use not merely in terms of network traffic or data exchanged, but rather in terms of services accessed, and therefore it can permit a tenant to ascribe use to each of its users in units which are meaningful to the user, permitting the user to understand and control its use. The system and method disclosed herein permit usage data from many different nodes to be aggregated, and is therefore useful on a system that contains many virtual machines. The data is cached locally and can be aggregated when the nodes in question are not in use, which conserves network resources and minimizes the impact on network resources.

The terms and expressions which have been used in this specification are intended to describe the invention, not limit it. The scope of the invention is defined and limited only by the following claims.

What is claimed is:

1. A computer system for metering use of network-accessible computer resources by a plurality of users of said computer resources, each said user associated with a tenant client computing device, said system comprising:
a) two or more tenant client computing devices interconnected by a network with one multi-tenant system, wherein said multi-tenant system comprises a load balancer and access control device, a server computing device, and a consolidated usage store; and
b) software recorded on a computer-readable medium for performing the steps of:
i) Receiving a request to use resources from a tenant client computing device via said load balancer and access control device and subsequently performing usage measurement initiation instructions,
ii) Processing said usage measurement computation instructions and recording usage measurement data in a local memory cache on occasions when resource usage has occurred,
iii) Periodically detecting recordation of said usage measurement data in said local memory cache, and
iv) Aggregating said usage measurement data in said consolidated usage store.

2. The system of claim 1 wherein said detecting of said recordation of usage measurement data occurs when the node in which said usage measurement data is recorded is not otherwise in use.

3. The system of claim 1 wherein said software recorded on a computer-readable medium further performs the step of consolidating said usage measurement data.

4. The system of claim 3 wherein said consolidation is performed by adding said usage measurement data to usage measurement data which is already present in said consolidated usage store.

5. The system of claim 1 wherein said software recorded on a computer-readable medium further performs the step of removing said resource usage data from said local memory usage cache after said resource usage data has been aggregated in said consolidated usage store.

6. A method for metering the use of network-accessible computer resources by a plurality of users of said computer resources, each said user associated with a tenant client computing device, said method comprising:
a) providing two or more tenant client computing devices interconnected by a network with one multi-tenant system, wherein said multi-tenant system comprises a load balancer and access control device, a server computing device, and a consolidated user store,
b) providing software recorded on a computer-readable medium,
c) generating and receiving a request by one said tenant client computing devices to use resources of said multi-tenant system, said request received by said load balancer and access control device,
d) performing usage measurement initiation instructions,
e) processing said usage measurement computation instructions and recording usage measurement data in a local memory cache on occasions when resource usage has occurred,
f) periodically detecting recordation of said usage measurement data in said local memory cache, and
g) aggregating said usage measurement data in said consolidated user store.

7. The method of claim 6 wherein said detecting of said recordation of usage measurement data occurs when the node in which said usage measurement data is recorded is not otherwise in use.

8. The method of claim 6 wherein said software recorded on a computer-readable medium further performs the step of consolidating said usage measurement data.

9. The method of claim 8 wherein said consolidation is performed by adding said usage measurement data to usage measurement data which is already present in said consolidated usage store.

10. The method of claim 9 wherein said software recorded on a computer-readable medium further performs the step of removing said resource usage data from said local memory usage cache after said resource usage data has been aggregated in said consolidated usage store.
